(19) United States
(12) Patent Application Publication
(10) Pub. No.: US 2003/0033872 A1
(43) Pub. Date: Feb. 20, 2003

(54) Water jacket mechancial fluid level monitoring device for cell-culture laboratory incubators

(76) Inventors: Brian W. Adkins, Pisgah Forest, NC (US); Charles G. Butts, Weaveruille, NC (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 09/930,966

(22) Filed: Aug. 17, 2001

(51) Int. Cl. G01F 23/02

(52) U.S. Cl. 73/323

(57) ABSTRACT

Methods and apparatus for mechanical fluid level monitoring device, which are particularly suited for a water jacket of an incubator are disclosed. The present invention provides a mechanical fluid level mechanism for monitoring water jacket levels in an incubator, including a liquid level gauge having a scale, which is mounted on the incubator.

### FIELD OF THE INVENTION

The present invention relates generally to the monitoring of water jacket levels within a controlled gas atmosphere enclosure. More particularly, the present invention concerns methods and apparatus for monitoring the water jacket level by mechanical means within an incubator environment.

### BACKGROUND OF THE INVENTION

Incubators are typically used for growing cultures in a controlled environment wherein both temperature and atmospheric gas concentration are maintained at selected levels. For certain applications it is highly desirable to have both temperature and gas concentrations maintained within strict tolerances while still allowing easy access to the incubator chamber for adding or removing items to and from the chamber or for inspecting the contents of the chamber. Control of environmental variables is desirable to maintain accuracy and reproducability of incubation results.

There are a number of commercial applications for controlled gas atmosphere enclosures including incubators. For example, electrical components and circuits are often tested in enclosures at a selected temperature and/or relative humidity for a period of time. Another common application for controlled atmosphere enclosures is the growth of biological cultures in a laboratory.

Referring to FIG. 1, a typical enclosure of the foregoing type includes a generally cubical outer housing made up of five insulated walls which include a top 10, bottom 12, left side 16, right side 14, and rear 18 along with an insulated front door 19. The door 19 is mounted on hinges (not shown) on the front of one of the side walls and may be opened to permit access to the interior of the incubator. When the door 19 is closed, it is suitably sealed about its periphery to the housing walls to form the sixth wall of the housing. The incubator chamber, in which biological cultures are grown, is formed by the inner walls of the enclosure, inside the insulated outer walls, and typically includes shelves 17 upon which culture containers are placed. The shelves 17 are supported by suitable shelf supports inside the chamber.

Most incubators of this type are either water jacket incubators or forced draft incubators. Referring to FIG. 2, in a typical water jacket incubator 5 the inner chamber 25 is heated to the desired temperature by a sealed jacket of water 22 surrounding the five fixed sides (10, 12, 14, 16 & 18) of the incubator chamber 25. The water jacket 22 lies between the chamber wall 23 and the insulated housing walls and is heated by heating elements (not shown) in thermal contact with the water in the water jacket 22. Due to the thermal conductivity of water, the heat from the individual heating elements (not shown) is relatively evenly dispersed through the water in the water jacket 22, providing even heating of the chamber 25. These heating elements (not shown) are monitored by a control panel 11. Such even heating is desirable in order to provide a uniform temperature for the biological cultures in different areas within the chamber 25 and in order to prevent “cold spots” on the inner chamber wall 23 upon which condensation can form.

Although the heating of the chamber walls 23 in a water jacket incubator 5 is substantially uniform, the chamber atmosphere will stratify thermally if the chamber 25 atmosphere is undisturbed. When such stratification occurs, the temperature of the chamber atmosphere is greater at the top of the chamber 25 than at the bottom of the chamber 25. In addition, if a constituent gas concentration is maintained in the chamber 25, such as a particular CO₂ level, the constituent gas will also stratify within the chamber atmosphere. Consequently, it is desirable to maintain a certain rate of flow 28 of gas within the chamber 25 to assure uniformity of temperature and of constituent gases. In order to do this, typically a portion of the chamber 25 is separated from the main chamber area by a wall to define a duct 26 extending, for example, along a side of the chamber 25. A small blower or fan 24 is placed in the duct 26 and the chamber atmosphere is circulated, such as from a duct inlet 21 in the upper portion of the chamber 25 to a duct outlet in a lower portion of the chamber 25.

In a typical forced draft incubator, or water jacket incubator 5, if a constituent gas in the atmosphere of the incubator chamber 25 is to be maintained at a particular level, a probe (not shown) is introduced into the chamber 25, perhaps within the duct 26 through which the chamber atmosphere circulates. In the case of CO₂, for example, a CO₂ sensor (not shown) is introduced into the incubator chamber to measure the concentration of CO₂ therein. A source of CO₂ is then coupled to the interior of the chamber 25 through a controlled valve (not shown), with an automatic control system (not shown) actuating the valve as required to maintain the CO₂ concentration in the chamber 25 at a selected level.

The humidity in a forced draft incubator is also often controlled. Rather than introducing steam or water into the incubator chamber as may be done in the case of a water jacket incubator, in a forced draft incubator quite often a pan of water is placed upon the floor of the incubator chamber, and the recirculated chamber atmosphere is directed out of the bottom of a duct across the surface of the water in the pan. Due to the higher recirculation rates in a forced draft incubator, appropriate humidification of the chamber is obtained.

In either a forced draft or a water jacket incubator, sensors such as for CO₂ or humidity have typically been located within the chamber atmosphere itself, although perhaps within a recirculation duct, as earlier described. Such sensors in the chamber are subject to the chamber atmosphere, and a sensor can fail or suffer performance degradations due to contaminants or the accumulation of a coating on the sensor. The presence of such sensors in the incubator chamber itself also makes cleaning of the chamber interior more difficult. In fact, the very existence of a duct or the like for the circulation of the chamber atmosphere within the chamber introduces difficulties in cleaning the chamber.

Present practice requires the end user to monitor the water level of the cell-culture laboratory incubator's water jacket 22 in order to insure that the proper chamber temperature uniformity is maintained. Presently, the standard means of measuring water level in an incubator is accomplished through the use of a closed-loop, electrical conductivity system.

A small electrical signal is run through a conductor, that, when contacted by the water, closes a grounding loop signaling a controller. When the water level is inadequate, the control panel 11 illuminates a lamp and an audible alarm is sounded. This indicates to the operator that insufficient water level is present and must be corrected. Over time the conductor (that is submerged in the water) will become corroded and its electrical conductivity will become impaired.

However, even though adequate water level is present, a corroded conductor system will activate the alarm, and the indicator will alert the operator that the water level is insufficient. To correct the indicated problem, the operator adds water to deactivate the alarm. This will result in an over-filled condition and in many cases may damage the incubator.

The converse may also be the case. Due to the highly saturated condition in the ceiling area of the water jacket 22 (typical location of the “add-water” sensor), if the electrical insulator becomes saturated or electrically breaks down, the sensor will become electrically shorted and will not indicate a low water condition.

Temperature is maintained in the internal atmosphere of the water-jacketed cell culture incubator by heat conduction through the internal walls of the incubator. This is accomplished by elevating the temperature of the water or liquid media contained within the water jacket or thermos 22 surrounding the main body of the interior. The energy is subsequently conducted through the internal walls and radiated into the internal atmosphere of the incubator's working environment. Additionally, the working environment of the typical incubator contains a highly saturated environment. Due to the level of the operating temperature and high vapor content in the internal environment of the incubator, it is critical that all surface temperatures remain within approximately 0.5° C. of the air temperature to insure that condensation does not occur.

If the water level drops below the ceiling level or beyond, the wall surface temperature can drop below the stated critical temperature and condensation will begin on the wall surfaces. This is a large problem with respect to cell and tissue culture environments that must be sterile. The accumulated moisture can become contaminated and will ultimately contaminate the materials or cell cultures inside the incubator. To insure the water jacket's 22 water level remains at an acceptable level, it is monitored through a conductive liquid level sensor that alarms the user as the level falls to a critical level. Over time, the potential for sensor failure through conductor corrosion increases substantially.

Furthermore, a well known problem with incubator systems is that it is difficult for the user to easily and accurately monitor the water level of the water jacket in order to insure that the proper chamber temperature uniformity is maintained. This is especially true when sensor failure occurs due to corrosion of electrical components.

Therefore, it would be desirable to provide an incubator having the ability to monitor the water jacket level by a mechanical means rather than an electronic one.

### SUMMARY OF THE INVENTION

The foregoing needs have been satisfied to a great extent by the present invention which pertains to the filling and water level maintenance of the water-jacketed incubator cabinet, and which provides an additional layer of protection to the incubator and its contents. By providing a mechanical means of monitoring the level of the liquid in the incubator's water jacket, the product and its contents will have an independent, visual means of status verification in lieu of the present electronic type.

One object of the present invention is to provide a mechanical fluid level mechanism for monitoring water jacket levels in an incubator.

In particular, the present invention includes a feed tube attached to the outer shell of the jacket thermos. This tube is located at a level which coincides with that of the lowest indication point of the liquid level gauge. The full-tank level of the incubator's liquid thermos additionally controls the vertical height position of the level gauge. The maximum level of the gauge tube will be at a similar height as that of the maximum jacket fluid level. The liquid level indication gauge tube and scale will be easily visible and mounted flush with the front surface of the incubator so as to be in clear, unobstructed view of its status by the operator.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view showing the fill and drain features of a conventional water-jacketed incubator.

FIG. 2 illustrates a cross section of a conventional water-jacketed incubator.

FIG. 3 illustrates a front view of an incubator cabinet utilizing one embodiment of the present invention.

### DETAILED DESCRIPTION OF PREFERRED EMBODIMENTS OF THE INVENTION

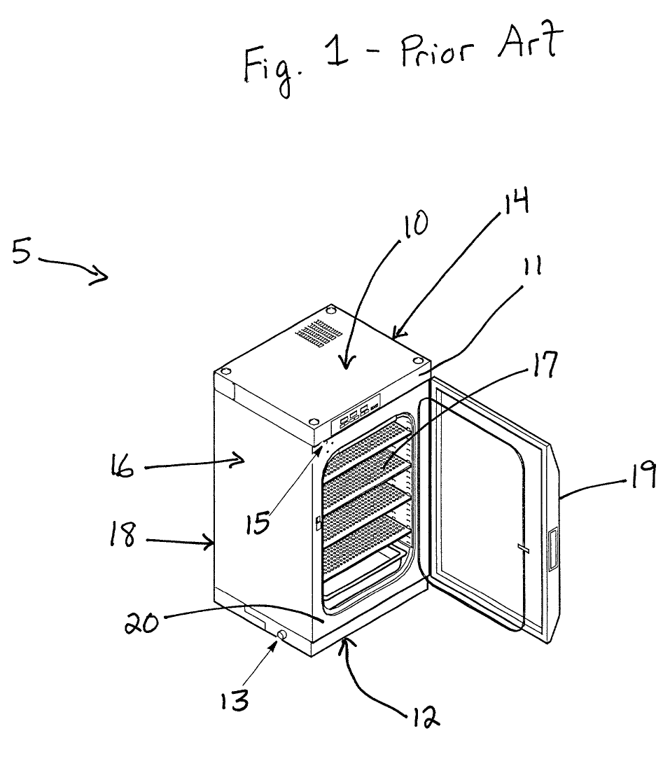

Referring to FIG. 1, wherein like reference numerals indicate like elements, a typical water jacket incubator 5 includes a generally cubical outer housing or cabinet made up of five insulated walls including top 10, bottom 12, left side 16, right side 14, and rear 18 and an insulated front door 19. The door 19 is mounted on hinges (not shown) on the front of one of the side walls and may be opened to permit access to the interior of the incubator 5. When the door 19 is closed, it is suitably sealed about its periphery to the housing walls to form the sixth wall of the housing. The incubator chamber 25, in which biological cultures are grown, is formed by inner walls, inside the insulated outer walls, and typically includes shelves 17 upon which culture containers are placed. The shelves 17 are carried by suitable shelf supports (not shown) inside the chamber 25. The fill hole 15 and drain lock 13 can be used to adjust the water level in the water jacket incubator 5.

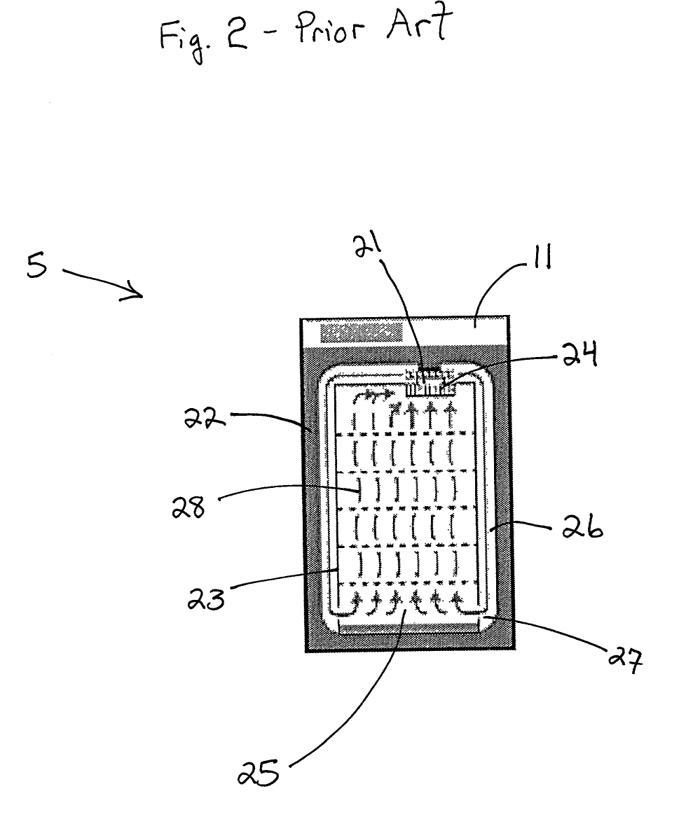

Referring to FIG. 2, wherein like reference numerals indicate like elements, in a water jacket incubator 5 the inner chamber 25 is heated to the desired temperature by a sealed jacket of water 22 surrounding the five fixed sides (not including the door 19) of the incubator chamber 25. The water jacket 22 lies between the chamber wall 23 and the insulated housing walls and is heated by heating elements (not shown) in thermal contact with the water in the water jacket 22. Due to the thermal conductivity of water, the heat from the individual heating elements (not shown) is relatively evenly dispersed through the water in the water jacket 22, providing even heating of the chamber 25. Such even heating is desirable in order to provide a uniform temperature for the biological cultures in different areas within the chamber 25 and in order to prevent “cold spots” on the inner chamber wall 23 upon which condensation can form.

Although the heating of the chamber walls 23 in a water jacket incubator 5 is substantially uniform, the chamber atmosphere will stratify thermally if the chamber atmosphere is undisturbed. When such stratification occurs, the temperature of the chamber atmosphere is greater at the top of the chamber 25 than at the bottom of the chamber 25. In addition, if a constituent gas concentration is maintained in the chamber 25, such as a particular CO₂ level, the constituent gas will also stratify within the chamber atmosphere. Consequently, it is desirable to maintain a certain rate of flow of gas within the chamber 25 to assure uniformity of temperature and of constituent gases. In order to do this, typically a portion of the chamber 25 is separated from the main chamber 25 area by a wall to define a duct 26 extending, for example, along a side of the chamber 25. A small blower or fan 24 is placed in the duct 26 and the chamber atmosphere is circulated, such as from a duct inlet 21 in the upper portion of the chamber 25 to a duct outlet 27 in a lower portion of the chamber 25.

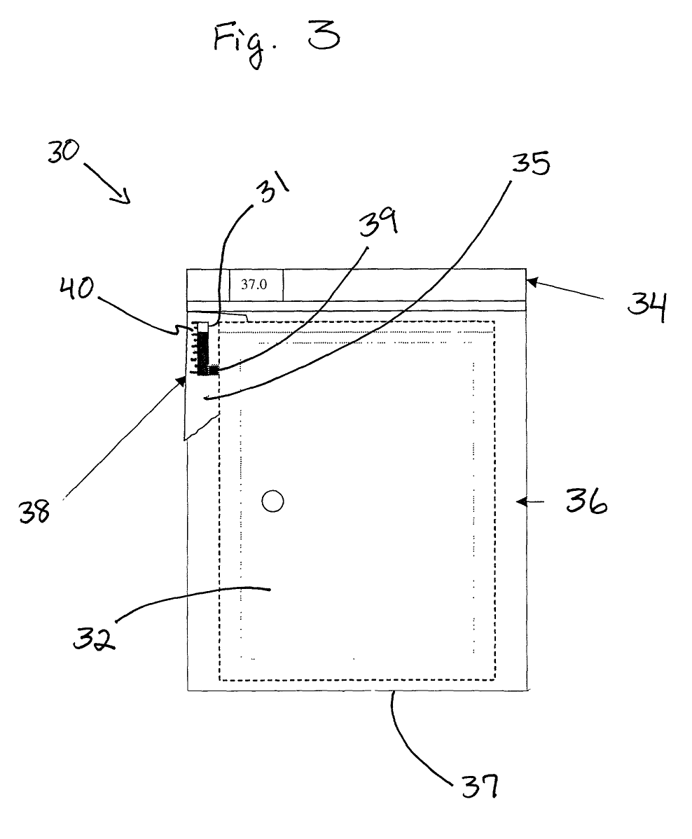

Referring to FIG. 3, wherein like reference numerals indicate like elements, the present invention pertains to the filling and water level maintenance of the water jacket incubator 30, and a mechanical fluid level mechanism 38 for monitoring water jacket 36 levels in the incubator 30.

As shown in FIG. 3, the present invention will provide an additional layer of protection to the incubator and its contents. By providing a mechanical means of monitoring the level of the liquid in the incubator's water jacket 36, the product and its contents will have an independent, visual means of status verification in lieu of the present electronic type.

The mechanical means includes a feed tube 39 attached to the outer shell of the water-jacket thermos 36. This tube is located at a level that coincides with that of the lowest indication point of the liquid level gauge tube 38 and scale 40. The full-tank level of the incubator's water-jacket thermos 36 additionally controls the vertical height position of the liquid level gauge tube 38 and scale 40. The maximum level of the gauge tube 38 and scale 40 will be at a similar height as that of the maximum jacket fluid level. The liquid level gauge tube 38 and scale 40 will be easily visible and mounted flush with the front surface 35 of the incubator 30 so as to be in clear, unobstructed view of its status by the operator.

The liquid level gauge tube 38 and scale 40 can be mechanically installed by a number of methods into the face or front surface 35 of the incubator cabinet 37. For example, installation can be a receiving slot or track (not shown) or by utilizing screws (not shown) to mount the liquid level gauge 38 and scale 40 flush with the face 35 of the incubator 30. The liquid level gauge tube 38 is connected to the water jacket thermos 36 with the lower elevation placed at a position that locates the liquid level's sight opening window 31 and scale 40 in an effective relationship that will provide a clear indication of the actual water level. The location is selected with relationship to the highest indication level equal to the greatest level attainable without creating an over-filled condition. As the water level begins to appear in the liquid level indicator, the filling process will continue until the full indication on the level gauge is met.

In operation, a user would mount the liquid level gauge into a slot or track (not shown) which is flush with the front face 35 of the incubator 30 and disposed behind a window 31. Next, a user would first visibly inspect the liquid level gauge tube 38 and scale 40 for the proper fill level through window 31. Next, if needed, the liquid level would be adjusted by either filling or draining the water jacket 36 accordingly until the liquid level gauge tube 38 and scale 40 indicated the proper fill level. This method of check and recheck could be applied accurately time after time since the mechanical liquid level gauge 38 and scale 40 are not vulnerable to corrosion or short circuiting like electronic ones.

The above description and drawings are only illustrative of preferred embodiments which achieve the objects, features, and advantages of the present invention, and it is not intended that the present invention be limited thereto. Any modification of the present invention which comes within the spirit and scope of the following claims is considered to be part of the present invention.

What is claimed is:

1. A mechanical fluid level monitoring device for an incubator, comprising:
a liquid level gauge; and
a scale disposed on said liquid level gauge,
wherein said incubator is substantially rectangular in shape with a front door coincident with a plane which includes a front face of the incubator.

2. The device of claim 1, wherein said liquid level gauge is disposed on said front face of said incubator.

3. The device of claim 1, wherein said scale is disposed on a front face of said incubator.

4. The device of claim 1, wherein said incubator is a water jacket incubator.

5. The device of claim 4, wherein said liquid level gauge is tubular.

6. The device of claim 5, wherein said liquid level gauge is connected to a water jacket thermos of said incubator.

7. The device of claim 6, wherein said scale indicates a full marking and a fill marking for said water jacket thermos.

8. The device of claim 1, wherein said liquid level gauge is visible when said incubator is closed.

9. The device of claim 6, further comprising a feed tube, wherein said feed tube is disposed between said water jacket thermos and said liquid level gauge.

10. A mechanical fluid level monitoring device comprising:
means for monitoring a level of fluid; and
means for adjusting the level of said fluid.

11. The device of claim 10, further comprising:
means for mounting the fluid level monitoring device into a front face of an incubator, wherein said monitoring device is mounted flush with said front face.

12. The device of claim 10, wherein said monitoring means is a mechanical liquid level gauge.

13. The device of claim 10, further comprising:
means for measuring a liquid level of said incubator.

14. The device of claim 11, wherein said incubator is a water jacket incubator.

15. The device of claim 13, wherein said measuring means is a scale mounted flush with the front face of the incubator.

16. The device of claim 11, wherein said adjusting means includes a fill hole and a drain lock disposed on said incubator.

17. The device of claim 11, wherein said means for monitoring includes a visible sight opening window disposed on said front face of the incubator.

18. The device of claim 16, wherein said monitoring means includes maximum and minimum liquid level indicators.

19. A method of mechanically monitoring a fluid level in an incubator environment comprising:
visibly monitoring a liquid level in said incubator by visibly measuring a maximum and a minimum liquid level of said incubator; and
adjusting said liquid level in said incubator.

20. The method of claim 19, wherein said incubator is a water jacket incubator.

21. The method of claim 19, wherein said measuring step includes viewing a scale mounted flush on a front face of the incubator.

22. The method of claim 21, wherein said scale indicates a full marking and a fill marking to indicate a condition of said water jacket.
